(19) United States
(12) Patent Application Publication
(10) Pub. No.: US 2012/0023007 A1
(43) Pub. Date: Jan. 26, 2012

(54) SYSTEM AND METHOD FOR CONSOLIDATION OF COMMERCIAL AND PROFESSIONAL UNDERWRITING

(76) Inventor: M. Mintu Bachann, Ponte Vedra, FL (US)

(21) Appl. No.: 13/247,871

(22) Filed: Sep. 28, 2011

Related U.S. Application Data
(63) Continuation of application No. 10/616,300, filed on Jul. 10, 2003.

(51) Int. Cl. G06Q 40/00

(52) U.S. Cl. 705/38; 705/35

(57) ABSTRACT

The invention provides an automated financial information management and processing system. The invention allows for the consolidation of commercial lending, commercial real estate lending, personal financial underwriting, risk assessment and decisioning into a single platform. The invention allows for the integration personal and corporate financial information for lending decisioning.

This application is a continuation under 35 U.S.C. §120 of U.S. patent application Ser. No. 10/616,300, filed on Jul. 10, 2003, which is hereby incorporated in its entirety by reference.

### BACKGROUND OF THE INVENTION

1. Field of the Invention

The invention relates to computerized financial information management and processing systems. More particularly, the invention provides a system, dynamic adaptive workflow and method providing consolidated and integrated commercial lending, commercial real estate lending and personal financial underwriting, risk assessment and decisioning in real-time (i.e., right now and/or six second decisioning).

2. Discussion of Related Art

Commercial financial underwriting, risk assessment and decisioning has historically been a fairly time and labor intensive process undertaken by financial institutions. In order to determine whether a potential borrower qualifies for financing, commercial lenders typically require that borrowers provide them with a variety of information, including individual and corporate asset and liability histories. Additional information can be obtained from credit bureaus, which maintain personal and commercial credit records. Lending institutions then make an evaluation of the potential borrowers to determine if they meet various lending criteria. Qualified borrowers are then extended credit while unqualified borrowers are declined and may be directed to alternative sources of financing.

The process of obtaining information needed to make a lending decision as well as evaluating potential borrowers is typically time and labor intensive. Each lending institution may have its own methodology for gathering information about a potential borrower and then evaluating the potential risks associated with lending to that potential borrower. Many of these processes require significant man-hours and evaluation by a hierarchy of loan processors, risk analysis, credit analysis and underwriters. Potential borrowers often have a number of complaints including: the slow speed of lending process, the repeated requests for additional information, reneging by the lending institutions of earlier terms during the evaluation process, and a lack of understanding of the borrower's business on the part of the lender. Thus, the conventional methodologies may require involvement by loan processors, credit analysts, customer service agents, underwriters, credit managers, loan officers and portfolio managers. Each of these individuals must complete their designated role before the process can move to the next individual. This can require a significant amount of time before a final decision can be made regarding a request for financing.

As described above, there is no common platform and dynamic workflow for lenders to reliably obtain, evaluate and subsequently underwrite a comprehensive set of current and historical financial data from potential commercial borrowers. There is also no common platform which integrates and automates many of the processes that make up the loan evaluation and decisioning process.

### SUMMARY OF THE INVENTION

The invention provides a common platform for consolidated and integrated commercial lending & commercial real estate lending and personal financial underwriting, credit risk analysis and decisioning. The common platform according to the invention allows for obtaining personal financial statements and commercial asset information and credit histories from potential borrowers, obtaining comprehensive property information and calculating historical operating performance (which takes into account, gross potential income, effective gross income, total operating expenses, NOI, debt service, net cash flow, property cash flow and DSC (NOI/debt service)), obtaining asset and credit information from third party credit bureaus, complete credit analysis including risk analysis and evaluation of the credit worthiness of a potential borrower, automated loan approval, and automated loan monitoring and review. The invention further provides comprehensive personal financial cash flow analysis, business cash flow analysis, property cash flow analysis and global debt service coverage (GDSC).

The invention allows integration of credit policies with risk assessment throughout an institution and identification of “global” cash-flow within an institution. Identification of “global” cash-flow includes the ability to recognize the commingling of business and personal funds. The invention allows credit managers, credit analysts and portfolio managers to set their own credit policy and credit risk criteria, perform covenant testing consolidate global debt service coverage, reduce delinquencies, improving underwriting consistency, increase loan volumes, improve risk-adjusted profitability and enhance overall customer satisfaction. The invention allows for the integration of credit policy and credit risk, business spreads and trend analysis collateral, projection, covenant, risk analysis, source and usage cash flow in a consolidated platform of both business and personal underwriting.

The invention allows commercial real estate underwriters to capture, synthesize and manipulate property information, historical earnings, market analysis, environmental analysis, appraisal analysis and make decisions from a single repository.

The systems and methods in accordance with the invention allows relationship managers, credit managers, loan processors, analysts and underwriters to gather and view multiple credit scores, set and modify credit policies, set alerts for covenants, collateral (tracking) and outstanding financial documents and manage a portfolio quickly. The invention further allows regulators to view all necessary documents from one central depository at any time.

The systems and method in accordance with the invention enable financial institutions to originate loans and make score and non-score based decisions.

Thus, one aspect of the invention is to provide a common platform for automated credit risk evaluation.

Another aspect is to provide a dynamic workflow for automated credit processing for financial institutions.

Another aspect of the invention is to provide a common platform for obtaining and evaluating personal and commercial asset and credit information.

Another aspect of the invention is to provide a “global” cash flow engine to allowing financial institutions to consolidate personal and business underwriting into one platform, set credit policy throughout an organization, gather intelligent feedback and analyze global credit risks, create global debt service coverage, streamline and automate mundane resource intensive credit processes, perform sensitivity covenants and make risk adjusted credit decisions efficiently and quickly.

In accordance with these and other aspects of the invention, the invention provides a method for commercial loan decisioning which includes consolidating financial information from at least one of a borrower, a guarantor and a property into a central database, calculating financial cash flow for at least one of the guarantor and the borrower and unifying individual and corporate financial wealth to determine global debt service. In accordance with an embodiment of the invention, the method for commercial loan decisioning may further include determining whether a loans to one borrower threshold is met, enabling a financial institution to regulate its credit policy and credit risk in relation to accepted regulations and enabling the financial institution to identify demographics.

The invention further provides a method for commercial loan decisioning which includes receiving a loan request, determining whether a threshold criteria is met, conducting a fraud check and a risk assessment, obtaining bureau data and financial spreads information and generating an automated underwriting decision based upon the bureau data and financial spreads information.

The invention further provides a consolidated lending and underwriting platform which includes a score-based decisioning engine for determining lending decisions utilizing individual financial information and corporate financial information and utilizing credit information from third party sources, a non-score based decisioning engine for determining lending decisions utilizing individual financial information and corporate financial information and utilizing historical data, balance sheets and cash flow and a commercial real estate engine for determining lending decisions related to the acquisition of properties.

If should also be appreciated that the functionality described herein may be included on electronic media as a computer program product.

In accordance with these and other aspects, the invention provides a common platform for obtaining personal and commercial credit histories and performing a comprehensive credit analysis, including risk assessment and notification of approval and terms and conditions.

### BRIEF DESCRIPTION OF THE DRAWINGS

The invention will be more clearly understood by reference to the following detailed description of an exemplary embodiment in conjunction with the accompanying drawings, in which:

FIG. 1 shows a block diagram of the loan processing platform in accordance with an embodiment of the invention;

FIG. 2 shows a process for underwriting in accordance with an embodiment of the invention;

FIGS. 3a-c are flowcharts illustrating the process for obtaining a risk assessment in accordance with an embodiment of the invention; and

FIG. 4 is a flowchart illustrating a loan processing workflow in accordance with the invention.

### DETAILED DESCRIPTION OF THE PREFERRED EMBODIMENTS

Reference will now be made in detail to embodiments of the invention, examples of which are illustrated in the accompanying drawings.

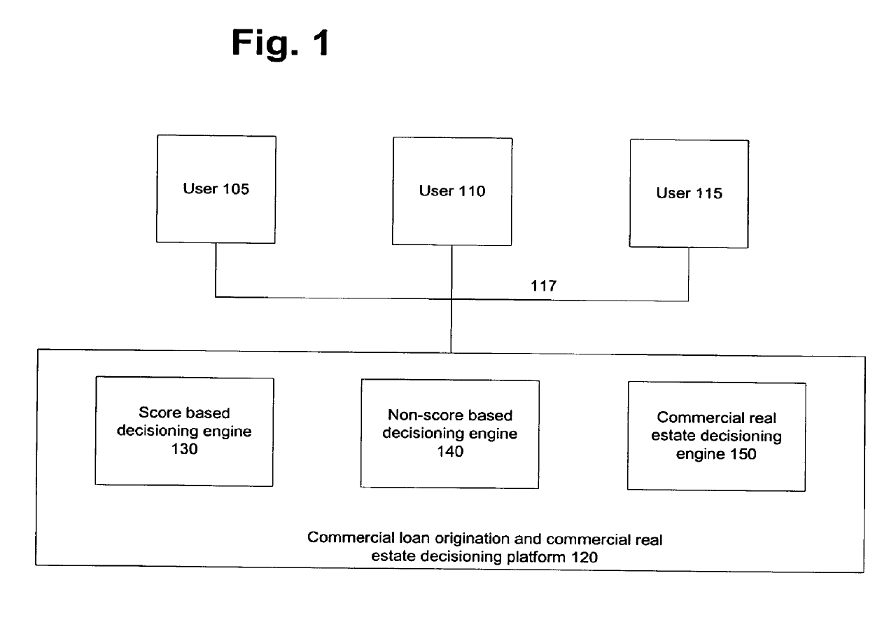

FIG. 1 shows the commercial loan origination and commercial real estate decisioning system in accordance with an embodiment of the invention. FIG. 1 shows an commercial loan origination and commercial real estate decisioning platform 120 for performing real-time risk analysis of potential borrowers and financing decisioning. The commercial loan origination and commercial real estate decisioning platform 120 is accessible to a plurality of users 105, 110 and 115 who may access the platform using user interfaces having access to the World Wide Web. In FIG. 1, the users can access the platform via connection 117 which may represent a network connection, a connection to the WWW via the Internet, a local area network (LAN), a virtual private network (VPN), a wireless network or any other system for coupling users to the platform 120. The users 105 may include, for example, loan processors, customer service representatives, underwriters, analysts, credit analysts, risk managers, portfolio managers and loan committee members. The commercial loan origination and commercial real estate decisioning platform 120 is capable of receiving asset and credit information from a variety of sources, including personal cash flow (asset) and credit data from individuals, commercial cash flow (asset) and credit data from commercial entities and third party cash flow (asset) and credit data from third party credit bureaus, such as credit reporting organizations. The platform 120 may include necessary communications and control interfaces for communicating with external data sources. The platform 120 may also include a data models, business logic and business models for providing comprehensive credit analysis, including risk analysis. It should be noted that the platform 120 may work across and in tandem with a financial institution's commercial loan approval platform.

By incorporating the personal and commercial asset and credit information, the platform 120 provides a “global” engine that evaluates a comprehensive set of data before making a risk assessment. In addition to asset and credit information, the system in accordance with the invention may examine additional information, such as tax returns which can affect the ability to compute asset values.

As part of the risk assessment process, the platform 120 gathers client information, prepares spreading statements, reviews the applications, reviews current financial performance, maintains loan portfolio information, monitors assets for compliance and covenants and reviews financing deals to determine whether they match with a potential borrowers corporate objectives. Thus, the platform outputs decisioning and risk analysis based upon the comprehensive data received by the platform 120.

The platform 120 may include a score based decisioning engine 130, a non-score based decisioning engine 140 and a commercial real estate decisioning engine 150. The score based decisioning engine 130 allows for the origination of loan applications from the web, origination based upon relationships, sales-force teams and origination from remote and distributed locations. The engine 130 allows relationship managers, credit managers, loan processors, analysts and underwriters to gather and view multiple credit scores, set and modify credit policies, set alerts for covenants, collateral (tracking) and outstanding financial documents. Regulators may view documentation at any time. The score based decisioning engine 130 is capable of generating a score based upon customer information from a variety of sources.

The non-score based decisioning engine 140 generates a score utilizing generally accepted accounting principles based upon both individual and business financial information. By examining both individual and business information, the non-score based decisioning engine 140 develops a comprehensive credit analysis. The non-score based decisioning engine 140 considers historical data, balance sheets, cash flow, income statements and other analytic information.

The commercial real estate engine 150, enables analysts and underwriters with rent roll, loan request summary, preliminary market information and historical operating performances, underwriting cash flow information and environmental and appraisal overview. The commercial real estate engine 150 provides instant reports including loan request summaries, subject property rent rolls, historical operating performances, appraisal and environmental information. Relationship managers, underwriters, loan officers all have immediate access to complete real estate information, including all of the factors that are considered when making a real estate lending decision.

Additional functionalities associated with the platform 120 are described in accordance with the methodologies discussed below. It should be noted that all of the functionalities described herein may integrated, for example, into an enterprise application with Object Oriented Programming (OOP) which may be built using J2EE technologies of which Enterprise JavaBeans (EJB) are an integral part. In addition, the platform 120, may reside at an applications server (not shown in FIG. 1) which is in communication with a webserver (not shown) and a database server (also not shown). The database server may store the wide array of financial information described herein.

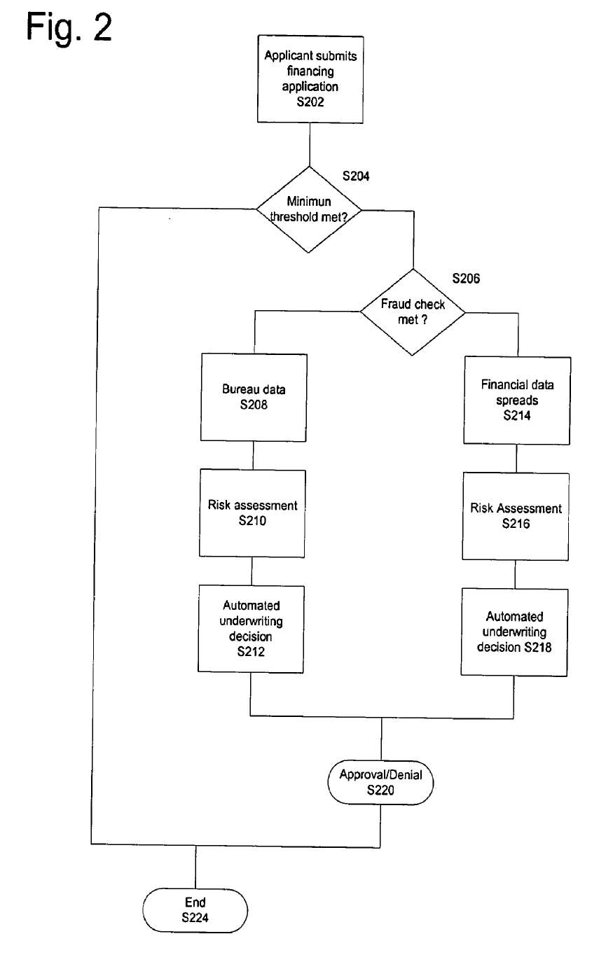

The overall process for credit processing in accordance with an embodiment of the invention is shown in FIG. 2. In FIG. 2, the process begins with step S202 where an applicant completes and submits an application for financing. In step S204, the system filters the application to determine whether certain baseline criteria are met. The baseline criteria can be any number of criteria set by the financial institution, including, for example, a minimum financing request or a minimum asset level. If the certain baseline criteria are not met, the process ends because the application has been rejected. If in step S204 the baseline criteria are met, the process moves to step S206.

In step S206, a fraud check is carried out. Also, if in step S206, the system shows a score based decision of less than a pre-determined amount, then the process moves to step S208, otherwise the process moves to step S214. In step S208, the bureau data is gathered from a variety of financing and credit information sources and the process moves to step S210. In step S210, a risk assessment is carried out and the process moves to step S212 where an automated underwriting decision is carried out. The process then moves to step S220 where the applicant is either approved or denied financing. The process then ends at step S224.

Returning to step S214, financial data spreads and balance sheet information are accumulated and evaluated and the process then moves to step S216. In step S216, a risk assessment is carried out and the process then moves to step S218. In step S218 and automated underwriting decision is carried out and the process then moves to step S220 where the applicant is either approved or denied financing. The process then moves to step S224 where it ends.

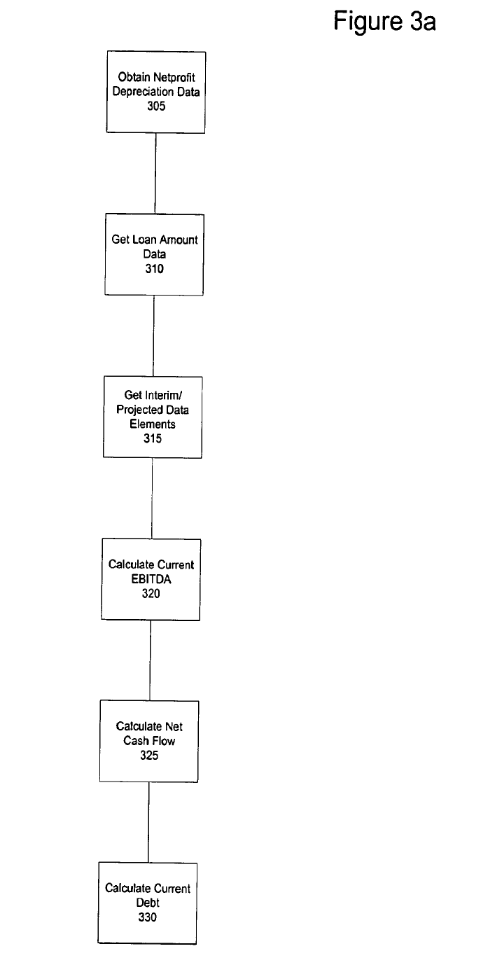

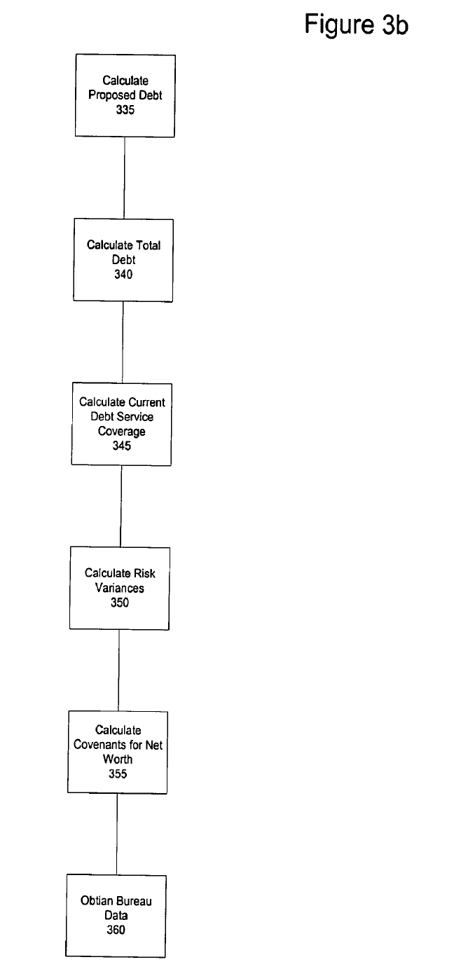

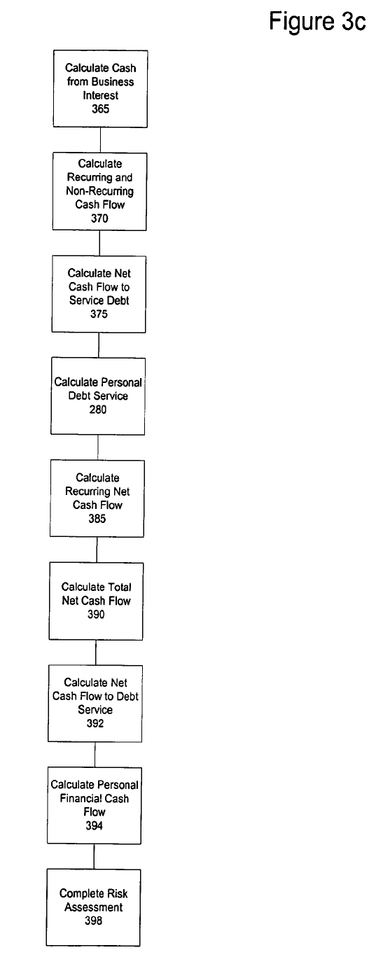

The process for carrying out a risk assessment in accordance with one embodiment of the invention is described in greater detail below in connection with FIGS. 3a-3c. It is important to note that the platform 120 as described above may be incorporated into an organization's existing financial databases.

FIGS. 3a-3c show a process for performing risk assessment in accordance with one embodiment of the invention. In FIG. 3a, the process begins with step S305. In step S305, the system first obtains data for net profit, interest expense, depreciation, amortization and dividends and data from OS data. The process then moves to step S310. In step S310, the system obtains the loan amount information from the analyst workflow. The process then moves to step S315.

In step S315, the system obtains all 275 data elements including interim & projected data elements, Balance Sheet, Operating Statement, Ratios and Variance. The process then moves to step S320 where the system calculates the current EBIDA. The process then moves to step S325. In step S325, the system calculates the net cash flow available for debt services, which is also called “less Div. and Dist.” The process then moves to step S330.

In step S330, the system calculates the current debt. The process then moves to step S335 (FIG. 3b). In step S335, the system calculates the proposed debt and the process moves to step S340. In step S340, the system calculates the total debt.

In step S345, the system calculates the current debt service coverage for PSOR. The process then moves to step S350. In step S350, the system calculates the risk variances for balance sheet, operating statement and ratio. The process then moves to step S355. In step S355, the system calculates covenants for net worth, debt/worth, and ratios. The process then moves to step S360.

In step S360, the system identifies and obtains data, including bureau data, loan amounts, terms and all tax information and then calculates personal cash flow. The process then moves to step S365. In step S365, the system calculates cash from business interest and the process moves to step S370. In step S370, the system calculates recurring and non-recurring cash flow and the process moves to step S375. In step S375, the system calculates net cash flow to service debt and the process moves to step S380. In step S380, the system calculates personal debt service and the process moves to step S385.

In step S385, the system calculates the recurring net cash flow and the process moves to step S390. In step S390, the system calculates the total net cash flow. The process then moves to step S392. In step S392, the system calculates the net cash flow to debt service. The process then moves to step S394 where the system calculates the personal financial cash flow. The process then moves to step S398 where the system completes the risk assessment. This assessment is then utilized to determine whether the potential borrower meets the lending criteria and if so, the terms and conditions of such financing.

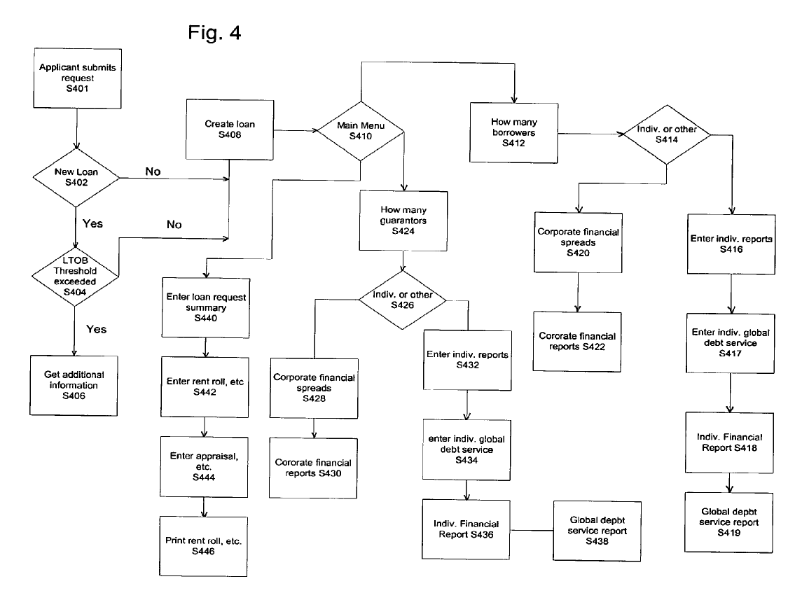

FIG. 4 shows a process flow for commercial loan and real estate loan processing in accordance with an embodiment of the invention. In FIG. 4, the process begins with step S401, where an applicant submits an application for financing. The type of financing may be any type of commercial or real estate financing. The process then moves to step S402 where the system determines whether a new loan request has been made, whether an existing loan request has been made or whether a new client is making the request. If the client or loan request is new, the process goes to step S404. Otherwise the process goes to step S408. In step S404, the system determines whether the requested loan exceeds a loans to one borrower standard. If the standard is exceeded, the process moves to step S404 where the process stops until the loan is authorized to move forward even though the threshold was exceeded. If the standard is not exceeded, the process moves to step S408.

In step S408, the loan request is generated by receiving a name for the project and/or the name of the property that is the subject of the loan request. The process moves to step S410. In step S410, a main menu offers a user with the selection of borrower information, guarantor information and/or property information. If the user selects borrower information, the process moves to step S412. If the user selects guarantor information, the process moves to step S424. If the user selects property information, the process moves to step S440.

In step S412, the system determines how many borrowers are at issue. Then, in step S414, the system determines whether the borrower is an individual or another type of entity. If the borrower is an individual, the process moves to step S416. Otherwise, the process moves to step S420. In step S416 individual financial information is entered into the system. Next, in step S417, individual global debt service information is entered. The process then moves to step S418 where individual financial reports are generated. Then, the process moves to step S419, where a global debt service report is generated. The process then ends. The invention contemplates several methodologies for calculating individual finances. In accordance with one embodiment of the invention, the individual financial analysis may be calculated as:

personal cash flow=total recurring income+business interest+non-recurring income+debt service (−personal debt)+net worth (total assets−total liabilities)

Returning to step S420, the company's financial spreads information is entered. This may include BS, OS, Rations, Recon and cash flow. The process then goes to step S422. In step S422, a financial report is then generated for the company and the process then ends.

Returning to step S424, the system determines the number of guarantors and the process then moves to step S426. In step S426, the system determines whether guarantor is an individual guarantor or another type of guarantor. If the guarantor is an individual, the process moves to step S432. If the guarantor is another entity, the process moves to step S428. In step S432, individual financial information is entered and the process goes to step S434. In step S434, an individual's global debt service information is entered and the process then moves to step S436. In step S436, individual financial reports are generated and the process then moves to step S438. In step S438, a global debt service report is generated and the process then ends. The total debt service coverage may be calculated as follows:

TDSC=Summation of {total loan commitment+annual gross income+annual operating expenses+annual debt service} where the NOI=(annual gross income−annual operating expenses) and DSC=(cash flow available/total debt)

Returning to step S428, a company's financial spreads are provided and the process then moves to step S430. In step S430, a corporate financial report is generated and the process then ends.

Returning to step S440, a summary of the requested loan is requested and the process then moves to step S442. In step S442, rent roll, financial history and underwriting criteria information is entered and the process then moves to step S444. In step S444, appraisal, market and environmental information is entered. The process then moves to step S446. In step S446, rent roll and historical performance information is then output. The process then ends. In this manner, an evaluation of a real estate financing request is made through the consideration of an individual's financial condition, an associated corporation's financial condition, along with other factors unique to the property to be financed, including regulatory issues, past owners, depreciation/appreciation of the property, and/or other factors relevant to any property.

As utilized above, annual global debt service is another factor considered when making financing determinations. Annual global debt service coverage can be calculated as follows:

[cash flow available (EBIDA(profit before taxes-deferred interest expenses=projected interest expenses+interest expense−capitalized interest=depreciation+amortization+cost of sales depreciation−current income tax+income tax credit+after tax income−after tax expense)−(withdrawals+dividends)/Total Debt Service (CPLTD+Interest Expenses+Proposed Debt Service))

It will be apparent to those skilled in the art that various modifications and variations can be made to invention without departing from the spirit or scope of the invention. For instance, the system of the present invention may be modified as needed to meet the requirements of computer networking schemes and configurations as they are developed. Thus, it is intended that the present invention covers the modifications and variations of this invention.

1. A method for commercial loan decisioning, comprising the steps of: consolidating financial information from at least one of a borrower, a guarantor and a property into a central database; calculating financial cash flow for at least one of the guarantor and the borrower; and unifying individual and corporate financial wealth to determine global debt service.

2. The method for commercial loan decisioning according to claim 1, further comprising the steps of: determining whether a loans to one borrower threshold is met; enabling a financial institution to regulate its credit policy and credit risk in relation to accepted regulations; and enabling the financial institution to identify demographics.

3. The method according to claim 2, wherein the borrower threshold is a minimum dollar amount.

4. The method according to claim 2, wherein the accepted regulations are at least one of governmental and banking regulations.

5. The method according to claim 2, wherein the demographics include at least one of an industry type and an industry sector.

6. The method according to claim 1, wherein the unifying step further includes the steps of: determining at least one of the number of borrowers and guarantors; obtaining individual financial information; obtaining individual global debt service information; generating an individual global debt service report; and generating an individual financial report.

7. The method according to claim 1, wherein the unifying step further includes the steps of: obtaining corporate financial information; and spreading and calculating corporate financial reports.

8. The method of claim 7, further comprising the steps of: obtaining a corporate global debt service information; and generating a corporate global debt service report.

9. The method according to claim 6, wherein the individual global debt service report includes at least one of asset information and a ratio between income and expenses.

10. The method according to claim 6, wherein the individual financial report includes at least one of a credit report, asset and liability information and tax information.

11. The method according to claim 7, wherein the corporate financial information includes at least one of current assets, liabilities and credit information.

12. The method according to claim 7, wherein the corporate financial reports include at least one of current asset information, non-current asset information; general liability information, net worth information, income, expenses and adjustments to earnings.

13. The method according to claim 6, wherein the individual financial information is calculated as: personal cash flow=total recurring income+business interest+non-recurring income+debt service (−personal debt)+net worth (total assets−total liabilities).

14. The method according to claim 6, wherein the individual global debt service information is calculated as: Individual Business name+entity type+business purpose+.SIGMA. Loan Commitment+.SIGMA. Annual Gross Income+.SIGMA. Annual Operating Expense+.SIGMA. Annual Debt Service+.SIGMA. NOI+.SIGMA. DSC

15. The method according to claim 8, wherein the corporate global debt service information is calculated as: {PSOR Company Data((cashflow available for annual debt service(EBIDA−(dividends+Withdrawals)+Personal Discretionary Cash)-Total Annual Existing and Proposed Debt Service (CPLTD+Interest Expense+Annual Principal and Interest)+Excess cash flow+Annual Debt Service Coverage)+SSOR Individual Data (Total Recurring & Non-recurring Cash Flow+Personal Annual Debt Service+Discretionary Cash Flows+PSOR Advanced Support to Negative Discretionary Cash Flow+Net Cash Flow for Debt Service+(Netcash Flow/Personal Debt Service))

16. The method according to claim 1, wherein a global debt service is calculated as:
TDSC=Summation of {total loan commitment+annual gross income+annual operating expenses+annual debt service} where the NOI=(annual gross income−annual operating expenses) and DSC=(cash flow available/total debt).

17. A method for commercial loan decisioning, comprising the steps of: receiving a loan request; determining whether a threshold criteria is met; conducting a fraud check and a risk assessment; obtaining bureau data and financial spreads information; and generating an automated underwriting decision based upon the bureau data and financial spreads information.

18. The method according to claim 17, wherein the threshold criteria is a minimum dollar value set by a financial institution.

19. The method according to claim 17, wherein step of conducting a fraud check includes screening information in the loan request against certain pre-determined fraud rules.

20. The method according to claim 17, wherein the step of generating an automated underwriting decision further includes the steps of: obtaining individual financial wealth information; obtaining corporate financial wealth information; and determining a global debt service based upon the individual financial wealth information and the corporate financial wealth information.
